(19) United States
(12) Patent Application Publication
(10) Pub. No.: US 2007/0066374 A1
(43) Pub. Date: Mar. 22, 2007

(54) Compactor control logic for a cotton harvester

(75) Inventors: Tracy A. Archer, West Liberty, IA (US); Yun Ren Ho, Naperville, IA (US); Timothy A. Meeks, Davenport, IA (US); Frank C. Dupire, Manheim, PA (US)

Correspondence Address: CNH AMERICA LLC;INTELLECTUAL PROPERTY LAW DEPARTMENT, P O BOX 1895, M.S. 641, NEW HOLLAND, PA, 17557, US

(73) Assignee: CNH America LLC

(21) Appl. No.: 11/229,889

(22) Filed: Sep. 19, 2005

(51) Int. Cl. A01F 12/60

(52) U.S. Cl. 460/119

(57) ABSTRACT

A system and method for controlling a compactor in a cotton harvester includes lowering a compactor frame to a first height to compact the cotton bolls, raising it to a second height, and distributing the cotton bolls fore-and-aft when the frame is at the second height. These steps may be repeated until a cotton module is built. The method is preferably computer-implemented.

### FIELD OF THE INVENTION

This invention relates generally to cotton harvesters with cotton module builders. More particularly, it relates to systems for monitoring and controlling the operation of compactors for creating the module.

### BACKGROUND OF THE INVENTION

Traditionally, the process of harvesting cotton included several steps. First, the cotton was gathered by a cotton harvester (called herein a “picker”) that traveled through the agricultural field separating the cotton bolls from the stalk and leaves of the cotton plant. The cotton bolls are then blown into a basket on the picker. Once the basket is full of loose cotton bolls, the picker either travels to a “module builder” which receives the loose cotton bolls, and compacts them to form a matted, compressed block or “module” of cotton, or alternatively loads the collected cotton bolls into a “boll buggy” (i.e. a wagon) that is configured to receive cotton bolls from the picker and transport them to the module builder. These modules are typically left in the field until a third vehicle can take them to a cotton gin for further processing.

In recent years this traditional process has been shortened. Instead of picking the cotton bolls, loading a boll buggy and taking it to a module builder, the step of picking and module building are combined. The picking and module building are performed simultaneously by a self-propelled picker/module builder. This picker/module builder travels through the field picking cotton and simultaneously building a module from that cotton.

The picker/module builder includes a header which harvests the cotton, strips it of leaf and stalk, and blows the cotton bolls into a chamber on the back of the picker/module builder. This chamber combines a basketlike structure with a compactor. The compactor is the device that moves up and down within the chamber to periodically compact the cotton bolls accumulating in the chamber. The compactor includes a compactor frame on which augers are mounted as well as hydraulic cylinders that are coupled to the frame to drive it up and down within the chamber. An electronic controller periodically cycles the compactor, causing the compactor frame to move up and down. This packs successive layers of cotton bolls that are blown into the chamber after being cut by the header. The header picks the cotton. Cotton is blown into the chamber by a separate system (i.e. conveyor fan, air ducts, chutes, etc.) on top of the compactor frame. Between compacting strokes, the compactor frame must be positioned relatively high in the chamber to permit the cotton bolls to pass through gaps in the frame and fall onto the top free surface of cotton in the chamber.

The compactor frame serves a second function as well: it distributes the cotton within the compactor chamber between compression strokes. The augers that are coupled to the compactor frame extend fore-and-aft within the chamber. They are raised and lowered together with the compactor frame. When properly positioned above the cotton, these augers engage the free top surface of cotton filling the chamber and rotate, pulling up most portions of the cotton forward or backward within the chamber to level the top surface.

It is desirable for the module of cotton to have as great a mass of cotton as can be achieved given the limited constraints of the module building machine. The most limiting of these constraints is the densification process of the cotton itself. It is difficult to achieve a very high density of cotton given the expanding characteristic of cotton fibers. Applying an external force from the compactor frame to a given amount of cotton will decrease the volume of this cotton, thereby increasing its density. This same amount of cotton tends to expand immediately after the external forces are removed, however, thereby resulting in comparable lesser density.

One of the difficulties in designing a cotton harvester with module builder is developing the operating logic for the compactor. In order for the cotton to be evenly compacted, the augers must be in close proximity to the top level of the compacted bed of cotton in the chamber. If the compactor frame is too high within the chamber the augers will not contact the surface of the cotton. If the compactor frame is too low within the chamber, pressing downward against the top surface of the cotton, the rotating augers will not move the cotton. Furthermore, unless the compactor frame is sufficiently high above the surface of the cotton as cotton is blown into the chamber, there will not be enough room for the cotton to pass through openings in the compactor frame and fall onto the top surface of cotton. If the compactor frame is too low in the chamber as the header blows free cotton into the chamber, cotton will not pass through the frame onto the top surface of the compacted cotton mass where it can be compressed by downward strokes of the compactor frame.

It should be clear that the most efficient operation of the compactor requires a balancing of the number of packing cycles (e.g. with the compactor frame lowered, pressing on the cotton), with the time spent distributing the cotton to make an even mass (e.g. with the compactor frame raised sufficiently above the surface of the cotton to permit the augers to move cotton), and with the time spent filling the chamber with new cotton to be compressed (e.g. with the compactor frame raised even higher to permit cotton bolls to fall through the frame and build up the top layer).

Furthermore, proper balancing of these factors may depend upon conditions of cotton harvest, such as the rate of cotton entering the chamber, the harvested cotton amount, the distribution of the cotton within the chamber, and height of packed cotton within the chamber.

What is needed is a system and method for cycling a compactor in a module builder. What is also needed, therefore, is a system and method for monitoring the conditions of cotton harvest, and determining the most efficient operation of the compactor. What is also needed is a system and method for determining efficient positions of the compactor during its several states of operation. It is an object of this invention to provide such systems and methods.

### SUMMARY OF THE INVENTION

In accordance with a first aspect of the invention, a method of controlling a compactor in a cotton harvester is provided, comprising the steps of lowering a compactor frame to a first height in the chamber, raising the compactor frame to a second height, distributing the compacted cotton bolls fore-and-aft; and sequentially repeating these steps while the harvester is travelling though the field harvesting cotton.

The first height may be a function of pressure acting on the compactor frame or pressure of the compactor frame on the cotton. The cotton distributor may be mounted on the compactor frame and each successive step of distributing may terminate when the cotton bolls provide a predetermined resistance to further distribution. The cotton distributor may be driven by a hydraulic motor and further wherein the predetermined resistance is a function of hydraulic pressure applied to the motor. The second height may be a function of or derived (at least partially) from the first height. It may include an offset that is also based upon or derived (at least partially) from the first height.

Each successive step of distributing may terminate when the cotton bolls provide a predetermined resistance to further distribution or when a predetermined interval of time has passed, whichever comes first. This predetermined resistance may be a function of hydraulic pressure acting on a hydraulic actuator.

In accordance with a second aspect of the invention, a system for controlling a compactor in a cotton harvester for harvesting cotton, the harvester having a cotton distributor in a chamber on the harvester is provided, the system comprising an electronic controller coupled to a compactor position sensor, a compactor actuator and a pressure sensor for sensing actuator pressure that is configured to drive the compactor frame to a first height in the chamber, to raise the actuator to a second height above the first height, to signal the distributor to distribute the cotton fore-and-aft, and to automatically repeat these steps while the harvester is travelling through a field harvesting cotton.

The position sensor may sense the position of the compactor in the chamber. The actuator may drive the compactor up and down within the chamber. The pressure sensor may sense the compacting pressure applied by the compactor to the cotton. The controller may drive the compactor frame to a first height based upon the pressure sensor indicating a predetermined hydraulic actuator pressure. The cotton distributor may be mounted on the compactor frame and the controller may be configured to stop the distributor when the cotton bolls provide a predetermined resistance to further distribution.

The distributor may include a hydraulic motor. The system may comprise a second pressure sensor that is disposed to sense the hydraulic motor's pressure and to indicate motor pressure to the controller. The controller may be configured to stop the hydraulic motor when the hydraulic motor pressure indicates the distributor has reached the predetermined resistance.

The controller may be configured to calculate the second height by combining the first height with a height offset. The controller may be configured to stop the distributor when the cotton bolls provide a predetermined resistance to further distribution or when the distributor has been driven for a predetermined time, whichever comes first.

In accordance with a third aspect of the invention, a system for controlling a compactor in a cotton harvester that travels through a field harvesting cotton bolls and sends the cotton bolls to a module building chamber on the harvester is provided, the system comprising means for lowering a compactor frame to a first height in the chamber to compress the received cotton bolls; means for raising the compactor frame to a second height higher than the first predetermined height above the compacted cotton bolls; and means for distributing the compacted cotton bolls fore-and-aft.

The system may include means for determining the first height as a function of pressure acting on the compactor frame. The system may include means for terminating distributing when the cotton bolls provide a predetermined resistance to distribution. The means for distributing may be driven by hydraulic actuator means and the predetermined resistance may be a function of hydraulic pressure applied to the hydraulic actuator means. The system may further include means for calculating the second height as a function at least of the first height. The system may further include means for terminating distributing cotton bolls after a predetermined time of distributing cotton bolls.

### BRIEF DESCRIPTION OF THE DRAWINGS

FIG. 1 is a side view of a cotton harvester with cotton module builder, (or “picker/module builder”).

FIG. 2 is a schematic diagram of a cotton module builder control operable using a compactor position sensing routine.

FIG. 3 is a continuation of the schematic diagram of FIG. 2.

FIG. 4 is a fragmentary side view of the cotton module builder, showing compactor apparatus thereof tilted.

FIG. 5 is a fragmentary side view of the module builder showing the compactor apparatus tilted at a lowered position.

FIG. 6 is a high level functional operation diagram showing the operation of a compactor position routine as commanded by controller 106 in accordance with its associated electronic programmed instructions.

### DETAILED DESCRIPTION OF THE PREFERRED EMBODIMENTS

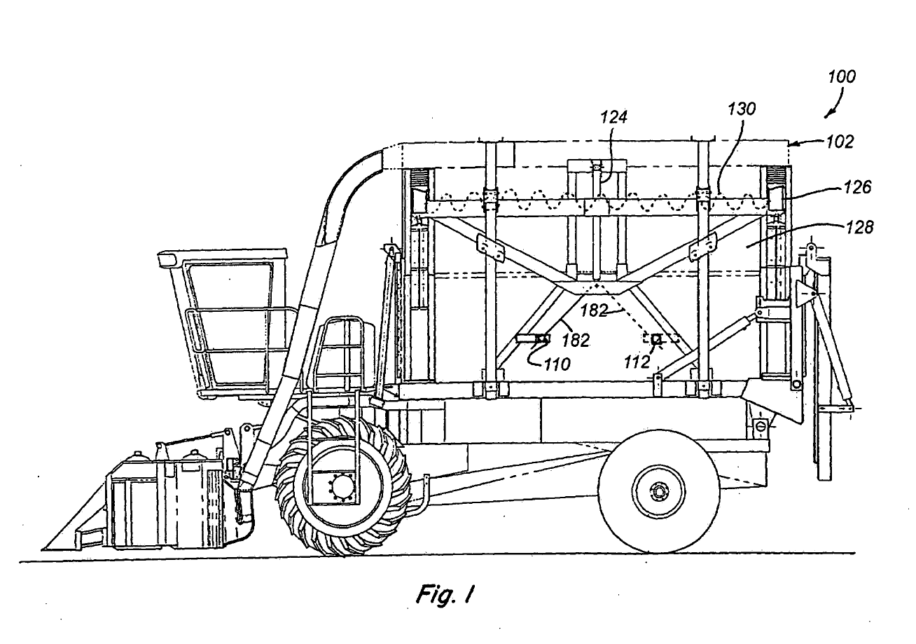

Turning now to the drawings, in FIG. 1, a cotton harvester 100 is shown that includes an on-board cotton module builder 102 for compacting cotton harvested by harvester 100 into a unitary cotton module (not shown). This is also called a “picker/module builder” herein.

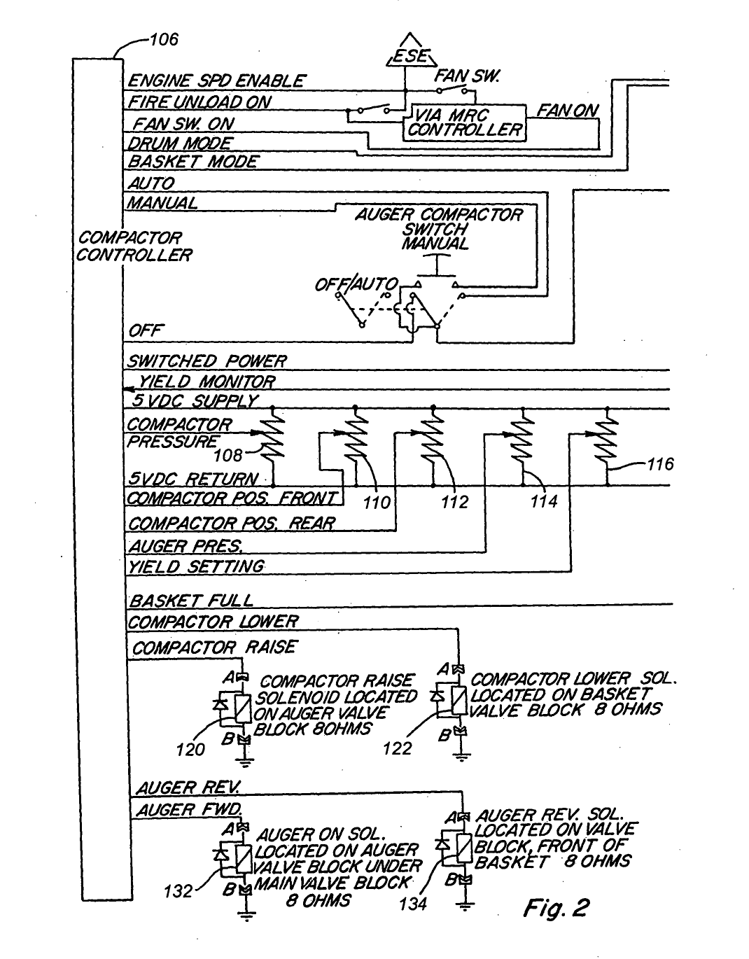

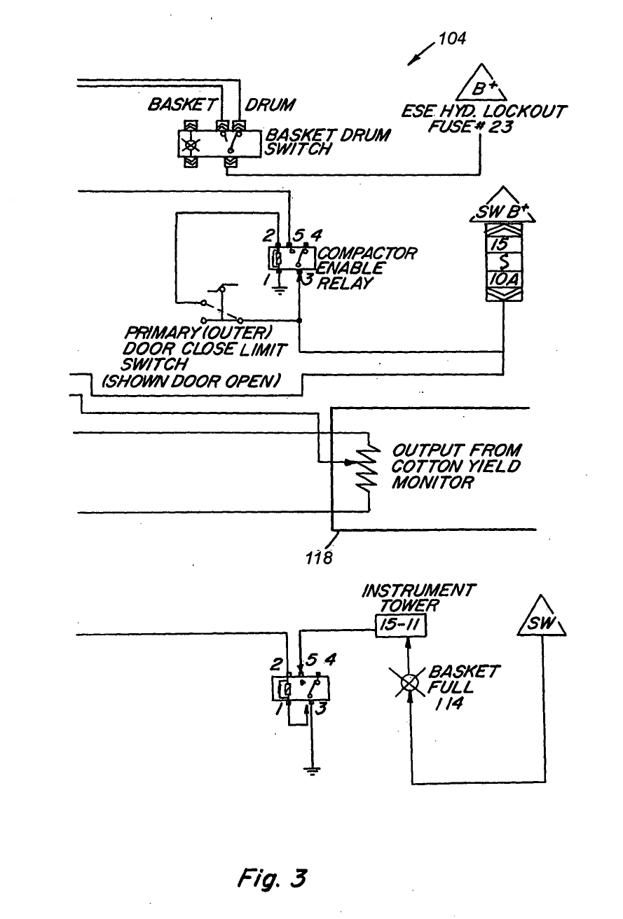

Referring also to FIGS. 2 and 3, circuitry of a compactor control 104 operable according to the present invention is shown. Control 104 includes an electronic compactor controller 106 operable for receiving signals output by a number of devices, including, but not limited to, a compactor pressure signal from a compactor pressure sensor 108, compactor position signals output by two compactor position sensors 110 and 112, auger pressure signal output by auger motor pressure sensor 114, and a yield signal output by an operator controlled yield setting 116 or a cotton yield monitor 118. Responsive to the signals from these devices, and/or other devices, controller 106 is operable for automatically responsively outputting signals to apparatus such as a compactor raise solenoid 120 and a compactor lower solenoid 122, which control compactor drivers, e.g. hydraulic valves (not shown) that conduct fluid to and from fluid cylinders 124 of module builder 102 (FIG. 1) operable for moving compactor apparatus 126 of module builder 102 upwardly and downwardly (respectively) against cotton accumulated in a bottom region of a compactor chamber 128 of module builder 102. The drivers can also be used for setting or indexing the compactor position. Compactor control 104 is also operable for outputting signals to cotton distributors, such as augers 130 (FIG. 1) of compactor apparatus 126, for effecting forward or reverse rotation thereof via an auger forward solenoid 132 and an auger reverse solenoid 134.

The cotton distributors may be augers as illustrated herein. They may also be belts or chains with paddles, rods or hooks mounted thereon to grab loose cotton. They may also include non-contact distribution devices like air jets.

Compactor controller 106 is preferably a digital microcontroller such as one of the IQAN series of controllers manufactured by Parker Hannifin that include a display module (MDM) with integral main controller and an I/O module coupled to the MDM over a CAN bus. Alternatively, electronic compactor controller 106 may be a digital microcontroller such as a Pecktron XCM series of microcontrollers. Controller 106 also includes internal memory circuits which hold preprogrammed electronic instructions that control the operation of the picker/module builder as described herein.

Control 104 need not be an electrical or electronic circuit coupled to electronic components. It may be a hydraulic circuit or a pneumatic circuit incorporating variable fluid flow control valves that imitate the function of the electrical circuits described and illustrated herein.

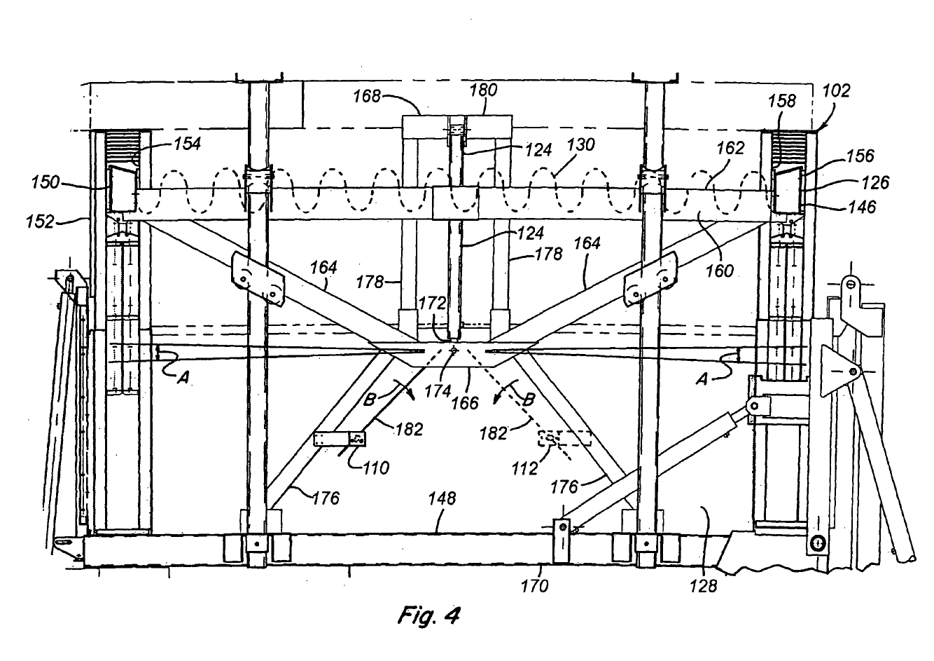

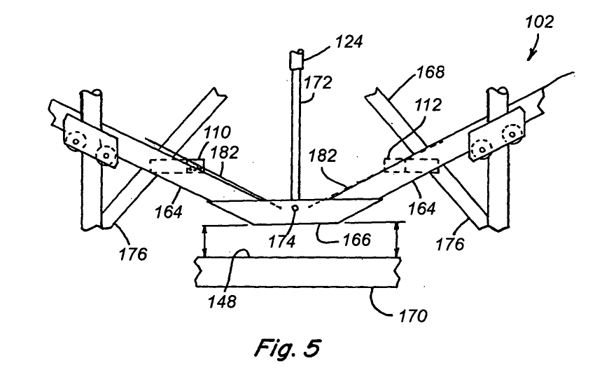

Referring to FIGS. 4 and 5, compactor apparatus 126 includes a compactor frame 146 which is oriented generally horizontally, or within a range of small acute angles relative to horizontal, and substantially entirely disposed within compactor chamber 128, for movement downwardly against cotton contained therein for compacting the cotton against a floor 148 therein. Compactor frame 146 includes a front cross member 150 disposed in chamber 128 adjacent a front wall 152, and having opposite ends which extend through sidewardly open slots 154 in module builder 102. Similarly, a rear cross member 156 is disposed in chamber 128 and has opposite end portions which extend through sidewardly open slots 158 in the module builder. Augers 130 are supported in forward and rearward extending relation between cross members 150 and 156 within chamber 128. Augers 130 can be rotated using any suitable commercially available drivers, such as a gear drive driven by a motor such as a fluid or electric motor, or directly by fluid or electric motors, as desired, and as controlled by auger solenoids 132 and 134, for distributing the collected cotton in chamber 128 as will be explained. In the preferred embodiment described herein, the auger motors (not shown) are hydraulic motors that are coupled to valves (not shown) to control the flow of hydraulic fluid to the motors in a conventional manner. These valves are opened and closed by auger solenoids 132 and 134. In this regard, it should be noted that it is desirable and a sought after feature to distribute the cotton evenly with respect to the plane of floor 148, such that the resultant compacted cotton module will have a substantially uniform height along its length and width.

Compactor frame 146 of compactor apparatus 126 is supported in compacting chamber 128 on each side by an exterior side structure 160, each structure 160 including a forwardly and rearwardly extending main beam 162 which extends between and connects front and rear cross members 150 and 156. Each side structure 160 additionally includes a pair of braces 164 which extend downwardly and at converging angles from front and rear cross members 150 and 156, and which are connected together by a gusset 166 located below the middle of main beam 162. Here, it should be noted that compactor frame 146 located within compacting chamber 128 and exterior side structures 160 on the exterior of module builder 102 are movable upwardly and downwardly together.

Importantly, a rod 172 of each cylinder 124 is connected to gusset 166 at a pivot 174 which allows limited pivotal movement of side structure 160 and thus compactor frame 146 and augers 130 of compactor apparatus 126 about a side-to-side extending pivotal axis within a limited range of pivotal movement, as denoted by arrows A.

Support frame 168 on each side of module builder 102 includes a pair of diagonally extending braces 176 having lower ends connected to frame 170, and upper ends which connect to and support vertical braces 178 which support a cross member 180 to which fluid cylinder 124 is attached. A more forward brace 176 of support frame 168 on that side of module builder 102 facing outwardly from the FIGURES, and the more rearwardly located brace 176 on the opposite side of the module builder, support the compactor position sensors 110 and 112, respectively. Each compactor position sensor 110 and 112 includes an elongate actuator arm 182 which pivotally connects to gusset 166 on that side of the module builder. Each sensor 110 and 112 is a rotary type sensor, which will detect rotational movement of the respective actuator arm 182, as denoted by arrows B, as compactor apparatus 126 is moved from the positions shown in FIGS. 1 and 4, for instance, to the lower position shown in FIG. 5. Because two compactor position sensors 110 and 112 are used, movements of compactor apparatus 126 at a tilt, such as denoted by arrow A, will result in different rotational displacements of actuator arms 182 of the respective sensors 110 and 112, and thus the sensors will output different positional values. Thus the signals generated by sensors 110, 112 indicate both the height of compactor frame 146, and its angle of tilt. The difference between the two signal values are utilized by controller 106 to determine both the vertical position of compactor apparatus 128, the magnitude of any tilt thereof, such as denoted by arrow A, and the direction of that tilt.

Compactor position sensors can include, for instance, potentiometers, which vary a voltage or current signal when an input thereof is rotated. Alternatively, compactor position sensors can include shaft encoders, or linear sensors (e.g. LVDTs) coupled to the compactor frame to detect the height of the frame at one or more positions. A linear sensor (e.g. for determining vertical height of the frame) and a rotational sensor (e.g. for detecting the tilt angle of the frame) can also be employed. Rotary sensors can also be employed to measure linear distance by rotationally coupling them to a rack, and fixing a rack on a movable structure such as the compactor frame. As the rack moves with respect to the compactor frame, the rotary sensor rotates. Alternatively, position sensors can also be disposed within or coupled to cylinders 124. “Smart cylinders” as they are known include integral position sensors to generate position signals indicating the degree of extension of the cylinders. Alternatively, a line may be wound around the shaft of a rotary sensor and may be attached to a structure (such as the compactor frame, or chamber) that moves with respect to the sensor. In this manner relative movement will rotate the shaft. The position sensors may also be hydraulic devices that change the flow rate or pressure of hydraulic fluid based upon their position. They may similarly be pneumatic devices that change the flow rate or pressure of air based upon their position.

The sensors do not need mechanical structures or linkages coupling them to and between compactor frame 146 and the compactor chamber or other structure with respect to which the compactor frame 146 moves. For example, noncontact sensors, such as laser, ultrasonic, or radar range-finding sensors can be employed to determine the position of the compactor frame with respect to the chamber. Similarly, the angular orientation of the compactor frame can also be determined using noncontact methods, such as (for example) by reflecting electromagnetic radiation (e.g. light, or radio waves) off the module builder, and receiving the reflected signal on an electromagnetic radiation detector. Using this arrangement, when the compactor frame is tilted the reflected signal will move across the detector. In yet another embodiment, an inductive sensor can be employed to detect the proximity (i.e. position) of the compactor frame with respect to the chamber.

The sensor need not be located in the positions illustrated herein. As long as the sensor indicates the relative movement of the compactor frame with respect to the rest of the chamber, and thus how full or empty the chamber is, the particular mounting point of the sensor is not essential.

In the embodiment illustrated herein, actuators 182 can be slidable relative to the input to prevent binding when rotated as denoted by arrows B, and also when rotated in the opposite direction. For instance, a vertical position of the compactor apparatus can be determined from an average of the values output by sensors 110 and 112.

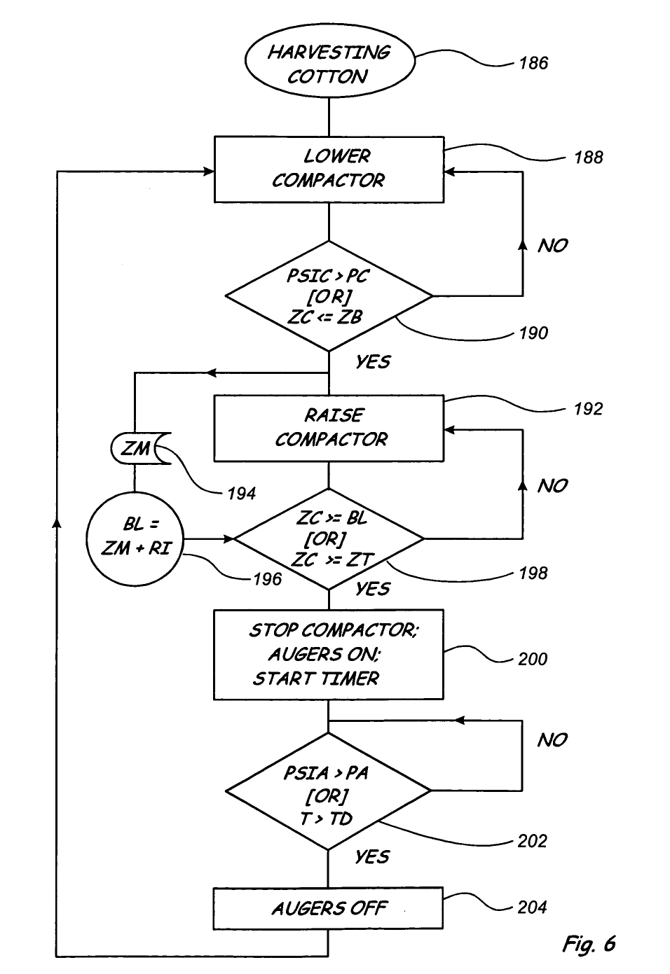

FIG. 6 shows the steps of a routine for compacting in distributing cotton in the chamber by compactor 126. These steps are performed by controller 106, which is configured to execute a series of electronic instructions stored in a memory circuit (not shown) of controller 106.

The operator first enters a harvesting mode indicated by block 186. While in this mode, controller 106 is configured to continuously and sequentially execute all the steps shown in FIG. 6 until harvesting ceases.

In the first step 188, controller 106 turns solenoid 122 “on”, thereby commanding it to lower compactor frame 146. Solenoids 120, 122 are coupled to hydraulic valves (not shown) which control the flow of hydraulic fluid to and from cylinders 124.

As the compactor frame is lowered in this manner, compactor 106 continuously checks certain conditions indicated by step 190. As long as these conditions are not met, controller 106 loops back to step 188 and keeps moving cylinders 124 downward toward the cotton.

Since the compactor frame 146 is initially quite high within the chamber, cylinders 124 meet no resistance and the pressure in cylinders (which controller 106 measures using pressure sensor 108) is negligible. Once the compactor frame makes contact with the cotton in the chamber and begins compacting the cotton, however, the resistance of the cotton to this compactor and further downward movement of cylinders 124 causes hydraulic fluid pressure to rise in cylinders 124.

Controller 106 is configured to lower the cylinder until the pressure in the cylinder (PSIC, which is proportional to the pressure applied by the compactor frame to the top of the cotton) exceeds a predetermined threshold pressure (PC, which is saved in a memory circuits of controller 106, and may be set by the operator), and as long as the height of the compactor frame (ZC) is greater than the height (ZB) of the bottom or floor of the chamber.

Controller 106 determines whether the pressure in the cylinder has exceeded a predetermined threshold pressure in block 190 by reading the signal from cylinder 124 pressure sensor 108 (PCIC) and comparing it with the threshold pressure (PC) each time step 190 is executed.

Controller 106 determines whether the compactor frame has reached the bottom of the chamber by comparing the height of the compactor frame, indicated by position sensors 110, 112, with a value indicating the compactor bottom position each time step 190 is executed.

Once cylinder pressure has risen to the predetermined threshold pressure or the compactor frame has reached the floor of the chamber, as indicated in step 190, controller 106 then executes step 192, in which it signals solenoid 120 to begin raising the compactor frame. Controller 106 also calculates a desired height to which the compactor frame shall be raised in steps 194 and 196. In step 194, controller 106 saves the height of the compactor frame and its lowermost position when the pressure in cylinders 124 (PSIC) reached the predetermined threshold pressure (PC). This height indicates the lowermost position of the compactor frame, just before controller 106 signals cylinders 124 to begin raising the compactor frame in step 192.

Using this lowermost height of the compactor frame, controller 106 calculates a position slightly above that those position by adding a raise increment or height offset (RI) to the lowermost height of the compactor frame (ZM). This raised position (BL) is calculated to reduce the pressure of compactor frame 146 on top of the cotton, permitting augers 130 to move cotton forward or backward within the chamber.

RI (and hence BL) is preferably a function of the height of the compactor frame 146 in the chamber at its lowermost extension, the moment when PSIC has risen to be greater than PC in step 190 as measured by controller 106.

Having calculated BL, controller 106 executes step 198. In step 198, controller 106 determines whether the height of the compactor frame (ZC) has risen at least by height offset RI. In other words, controller 106 determines whether the height of the compactor frame exceeds height BL. Again, controller 106 determines height ZC of the compactor frame by reading height signals generated by position sensors 110, 112.

If the measured compactor frame height ZC does not exceed the target height BL, controller 106 loops back to step 192, and keeps raising compactor frame 146. Eventually, however, the compactor frame will reach height BL, at which point controller 106 will execute step 200.

As cotton harvest progresses and chamber 128 fills with cotton, the target height BL calculated by controller 106 will eventually become greater than the upper position limit (ZT) of the compactor frame 146. Controller 106 is configured to compare ZC with ZT (step 198) to determine whether ZC is greater than or equal to ZT, and, when this is true, to execute step 200.

In step 200, controller 106 stops further upward movement of the compactor frame 146 by turning off solenoids 12. This action closes the valves that supply hydraulic fluid to the cylinders, and the cylinders stop moving.

Further in step 200, controller 106 is configured to turn the augers on, rotating them in a direction calculated to level the cotton in the chamber. In the preferred embodiment, controller 106 determines which direction to rotate the augers based upon the angle of the compactor frame 146. Controller 106 determines what the angle of the compactor frame is by examining the position signals of position sensors 110, 112. From the geometry of the module builder shown in FIGS. 1, 4-5, it should be clear that as the compactor frame 146 is tilted from one orientation (i.e. higher in the front than in the rear) to another orientation (i.e. lower in the front than in the rear) sensors 110, 112 will change in output differently. The difference in signal output between sensor 110 and sensor 112 indicates the fore-and-aft angle of orientation of the compactor frame 146. Controller 106 is configured to determine the angle of orientation of the compactor frame, and based upon the angle of orientation to either drive the motors in a first direction calculated to pull cotton forward from the rear of the chamber, or in the second direction calculated to pull cotton from the front of the chamber rearward. Controller 106 is configured to choose the direction of rotation of the augers that will level the cotton out in the chamber.

Even further in step 200, controller 106 is configured to start a timer (T) that it periodically increments as time passes.

In step 202, controller 106 continuously measures the load on the augers, and continues to rotate the augers until the load reaches a predetermined level. This load is indicated by the measured hydraulic pressure in the auger (PSIA). Controller 106 determines the hydraulic pressure in the auger (PSIA) by reading the pressure signal provided by auger pressure sensor 114. As the load on the augers increases (i.e. as the cotton increasingly resists being moved by the auger) the hydraulic pressure in the auger (PSIA) increases. Whenever controller 106 determines that the pressure in the auger (PSIA) exceeds a predetermined threshold pressure (PA), it turns the auger “off” in step 204.

Further in step 202, controller 106 compares the incremented timer value (T) with a predetermined threshold dwell time (TD) to determine whether sufficient time (T) has passed since controller 106 turned the augers on. Whenever a period of time equal to the dwell time (TD) has passed, controller 106 is configured to exit step 202 and execute step 204, turning the augers off. Thus, occurrence of either (1) a predetermined time passing, or (2) a predetermined auger pressure) will cause controller 106 to turn the augers off.

Once the augers have been turned off in step 204, controller 106 automatically returns to step 188 and again compresses the cotton by lowering the compactor.

Steps 188-204 are executed sequentially and repeatedly as the picker/module builder travels through the field harvesting cotton. Once a complete module has been built, controller 106 stops executing these steps and prepares to unload the module into the field.

From the foregoing it should be clear that a system and method for cycling a compactor in a module builder has been provided. It is capable of monitoring the conditions in the builder chamber such as the angle of the top of the cotton, built height of the cotton, the pressure of the compactor frame pressing down upon the top of the cotton (indicated by the hydraulic pressure in cylinders 124), and the load on the augers that are pushing the cotton forward or backward within the chamber (indicated by the hydraulic pressure on the auger motors of sensor 114).

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates in the preferred embodiment of the invention; however, concepts, as based upon the description, may be employed in other embodiments without departing from the scope of the invention.

For example, rather than cylinders 124, the system could use rotary hydraulic actuators, pneumatic instead of hydraulic actuators, electrical actuators such as linear motors or rotary motors. It could also use cables, mechanical linkages, lead screws, levers, or other similar members to connect the actuators to the compactor frame. Even further, instead of two hydraulic cylinders with one disposed on either side of the vehicle, a single actuator could be provided. More than two actuators could be provided, for example 3, 4, or more. In addition, the actuators do not need to be fixed at the midpoint of each side of the compactor frame. They may, for example, be mounted at the corners, or staggered along the front, rear, or sides of the compactor frame.

As another example, rather than hydraulic motors and augers comprising the cotton distributor, pneumatic or electric motors can be used. Furthermore, the motors can be linear or rotary. Even further, the predetermined load or pressure on the cotton distributor can be indicated not only by pressure sensors, but by electrical current sensors, or the relative movement of mechanical components such as slippage of a clutch that is set to, for example, a predetermined load before it is released. It may also be indicated by pressure spikes, or the opening of a relief valve, or a switch, or flexure of a load bearing member, or strain gages or a sensor that senses any of the foregoing.

Accordingly, the following claims are intended to protect the invention broadly as well as in the specific form shown.

1. A method of controlling a compactor in a cotton harvester, comprising the steps of:
(a) driving the harvester through a field harvesting cotton bolls;
(b) receiving the harvested cotton bolls into a chamber;
(c) lowering a compactor frame to a first height in the chamber to compress the received cotton bolls;
(d) raising the compactor frame to a second height higher than the first predetermined height above the compacted cotton bolls;
(e) distributing the compacted cotton bolls fore-and-aft while the compactor frame is at the second height; and
(f) sequentially repeating steps (b), (c), (d), and (e) while the harvester is traveling though the field harvesting cotton.

2. The method of claim 1, further comprising the step of stopping the frame at the first height based upon pressure acting on the compactor frame.

3. The method of claim 1, wherein a cotton distributor is mounted on the compactor frame and further wherein each successive step of distributing terminates when the cotton bolls provide a predetermined resistance to further distribution by the cotton distributor.

4. The method of claim 3, wherein the cotton distributor is driven by a hydraulic motor and further wherein the predetermined resistance is a function of hydraulic pressure applied to the motor.

5. The method of claim 1, wherein the second height equals the first height plus an offset based upon the first height.

6. The method of claim 3, wherein each successive step of distributing terminates when the cotton bolls provide the predetermined resistance to further distribution or when a predetermined interval of time has passed, whichever comes first.

7. A system for controlling a compactor in a cotton harvester for harvesting cotton, the harvester having a cotton distributor, the system comprising:
a position sensor for sensing a position of the compactor within a module building chamber;
an actuator for driving the compactor up and down within the chamber;
a first pressure sensor for sensing compacting pressure applied by the compactor to the cotton; and
an electronic controller coupled to the position sensor, the actuator and the first pressure sensor and configured to drive the compactor to a first height in the chamber, then to raise the actuator to a second height above the first height, then to signal the distributor to distribute the cotton fore-and-aft, then to automatically repeat the driving, raising and signaling steps while the harvester is traveling through a field harvesting cotton.

8. The system of claim 7, wherein the controller drives the compactor to a first height based upon the first pressure sensor indicating a predetermined pressure on the actuator.

9. The system of claim 7, wherein the cotton distributor is mounted on the compactor and further wherein the electronic controller is configured to stop the distributor when the cotton bolls provide a predetermined resistance to further distribution by the distributor.

10. The system of claim 9, wherein the distributor includes a hydraulic motor, and further wherein the system further comprising a second pressure sensor that is disposed to sense a hydraulic pressure of the hydraulic motor and to indicate the hydraulic pressure to the controller, and further wherein the controller is configured to stop the hydraulic motor when the hydraulic pressure indicates the distributor has reached the predetermined resistance.

11. The system of claim 7, wherein the controller is configured to calculate the second height by combining the first height with a height offset.

12. The system of claim 9, wherein the controller is configured to stop the distributor when the cotton bolls provide the predetermined resistance to further distribution or when the distributor has been driven for a predetermined time, whichever comes first.

13. A system for controlling a compactor in a cotton harvester that travels through a field harvesting cotton bolls and sends the cotton bolls to a module building chamber on the harvester, the system comprising:
means for lowering a compactor frame to a first predetermined height in the chamber to compress the received cotton bolls;
means for raising the compactor frame to a second predetermined height higher than the first predetermined height above the compacted cotton bolls; and
means for distributing the compacted cotton bolls fore-and-aft.

14. The system of claim 13, further comprising means for determining the first predetermined height as a function of pressure acting on the compactor frame.

15. The system of claim 13, further comprising means for terminating distributing when the cotton bolls provide a predetermined resistance to distribution.

16. The system of claim 15, wherein the means for distributing is driven by a hydraulic actuator means and further wherein the predetermined resistance is a function of hydraulic pressure applied to the hydraulic actuator means.

17. The system of claim 13, further comprising means for calculating the second height as a function at least of the first height.

18. The system of claim 15, further comprising means for terminating distributing cotton bolls after a predetermined time of distributing cotton bolls.
